(19) United States
(12) Patent Application Publication
(10) Pub. No.: US 2025/0200221 A1
(43) Pub. Date: Jun. 19, 2025

(54) PRIVACY DATA OPERATIONS

(71) Applicant: The Los Angeles Trust for Children’s Health, Los Angeles, CA (US)

(72) Inventors: Patricia Anton, Los Angeles, CA (US); Maryjane Puffer, Los Angeles, CA (US)

(73) Assignee: The Los Angeles Trust for Children’s Health, Los Angeles, CA (US)

(21) Appl. No.: 18/969,836

(22) Filed: Dec. 5, 2024

Related U.S. Application Data
(60) Provisional application No. 63/609,615, filed on Dec. 13, 2023.

(51) Int. Cl. G06F 21/62

(52) U.S. Cl. CPC G06F 21/6254; G06F 21/6227

(57) ABSTRACT

A method for a plurality of administration engines on remote processing devices coupled to an anonymization engine operable to replace personally identifiable information (PII) with a unique identifier, further coupling the administration engines to a server and transmitting queries to the administration engines and receiving results in response to the querying. Then associating the contextual information in response to the unique identifiers, and formatting the contextual information to ensure data compatibility. Certain embodiments may include academic and health information.

### PRIORITY

This application claims the benefit of co-pending provisional patent application 63/609,615 filed Dec. 13, 2023 by the same inventors which is included by reference, together with its Appendix, as if fully set forth herein.

### BACKGROUND OF THE INVENTION

A major problem with structured data storage is the ability to maintain confidentiality even if access to the data store is somehow compromised. This is most readily apparent for the storage of medical information, where the Health Insurance Portability and Accountability Act (HIPPA) provides for a very high degree of privacy even within a single institution. Similarly academic records are protected by the Family Educational Rights and Privacy Act (FERPA) which also requires a high degree of privacy. Moreover, other organizations that could benefit from access to health or education information are also required to maintain privacy. For example, and without limitation, academia and corrections organizations.

Unfortunately, this high degree of privacy prohibits the easy collation, sharing and transfer of information between people and organizations that could benefit from easy access to the information. The high degree of privacy associated with data prohibits cross-sector collaboration that is necessary to address and eliminate the root causes of some complex problems. Complex problems being things like how childhood health impacts education and how level of education in turn impacts risky behaviors, incarceration, economic instability, and early deaths. Moreover schools may not have access to medical information, nor may insurance companies have access to school medical data.

For example, and without limitation, a psychiatrist treating a person suffering a mental health crisis would not have any way to easily access medical, dental and correctional data from various databases. Even if that data was technically accessible, the HIPPA or FERPA requirements would bar any personal identifiable information (PII) from being disclosed.

Similarly, large record sets of medical and other research data needs to be scrubbed of PII before it can be shared thus severely limiting the ability to cross index datasets to look for any cross correlations in the data and a person's medical history, treatment and subsequent results. The inability to perform cross-sector collaboration between entities hampers research and hides information that may be valuable in solving societal problems.

Presented herein are systems and methods for addressing these well-known deficiencies in data management of personal identifiable information from differing organizations.

### SUMMARY OF THE INVENTION

Disclosed herein is a method for a plurality of administration engines on remote processing devices coupled to an anonymization engine operable to replace personally identifiable information (PII) with a unique identifier, further coupling the administration engines to a server. The server transmitting queries to the administration engines and receiving results in response to the querying. The results may include contextual information based on the source of the information. For example, and without limitation, academic information, health information, criminal justice information and the like. Then associating the contextual information in response to the unique identifiers, and formatting the contextual information to ensure data compatibility.

Once the anonymized contextual information is standardized, data analysis may be performed to glean relevant information. For example, and without limitation, for the first time ever, student academic data such as attendance records are able to be analyzed in relationship with the medical care and services those students have received for cross-sector collaboration to solve complex problems. This provides for academic officials to see previously unknown relationships and tailor programs in response to those relationships.

### BRIEF DESCRIPTION OF DRAWINGS

FIG. 1 shows a functional block diagram of a client server system.

FIG. 2 shows a functional block diagram of a system according to the present disclosure.

FIG. 3 shows a diagram of an anonymizing process.

FIG. 4 illustrates certain operations of an administration engine.

### DETAILED DESCRIPTION OF THE INVENTION

### Generality of Invention

This application should be read in the most general possible form. This includes, without limitation, the following:

References to specific techniques include alternative and more general techniques, especially when discussing aspects of the invention, or how the invention might be made or used.

References to “preferred” techniques generally mean that the inventor contemplates using those techniques, and thinks they are best for the intended application. This does not exclude other techniques for the invention and does not mean that those techniques are necessarily essential or would be preferred in all circumstances.

References to contemplated causes and effects for some implementations do not preclude other causes or effects that might occur in other implementations.

References to reasons for using particular techniques do not preclude other reasons or techniques, even if completely contrary, where circumstances would indicate that the stated reasons or techniques are not as applicable.

Furthermore, the invention is in no way limited to the specifics of any particular embodiments and examples disclosed herein. Many other variations are possible which remain within the content, scope and spirit of the invention, and these variations would become clear to those skilled in the art after perusal of this application.

### Lexicography

The term “declarative language” generally refers to a programming language that allows programming by defining the boundary conditions and constraints and letting the computer determine a solution that meets these requirements. Many languages applying this style attempt to minimize or eliminate side effects by describing what the program should accomplish, rather than describing how to go about accomplishing it. This is in contrast with imperative programming, which requires an explicitly provided algorithm.

The terms “effect”, “with the effect of” (and similar terms and phrases) generally indicate any consequence, whether assured, probable, or merely possible, of a stated arrangement, cause, method, or technique, without any implication that an effect or a connection between cause and effect are intentional or purposive.

The term “relatively” (and similar terms and phrases) generally indicates any relationship in which a comparison is possible, including without limitation “relatively less”, “relatively more”, and the like. In the context of the invention, where a measure or value is indicated to have a relationship “relatively”, that relationship need not be precise, need not be well-defined, need not be by comparison with any particular or specific other measure or value. For example and without limitation, in cases in which a measure or value is “relatively increased” or “relatively more”, that comparison need not be with respect to any known measure or value, but might be with respect to a measure or value held by that measurement or value at another place or time.

The term “substantially” (and similar terms and phrases) generally indicates any case or circumstance in which a determination, measure, value, or otherwise, is equal, equivalent, nearly equal, nearly equivalent, or approximately, what the measure or value is recited. The terms “substantially all” and “substantially none” (and similar terms and phrases) generally indicate any case or circumstance in which all but a relatively minor amount or number (for “substantially all”) or none but a relatively minor amount or number (for “substantially none”) have the stated property. The terms “substantial effect” (and similar terms and phrases) generally indicate any case or circumstance in which an effect might be detected or determined.

The terms “this application”, “this description” (and similar terms and phrases) generally indicate any material shown or suggested by any portions of this application, individually or collectively, and include all reasonable conclusions that might be drawn by those skilled in the art when this application is reviewed, even if those conclusions would not have been apparent at the time this application is originally filed.

### Specification

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

The methods and techniques described herein may be performed on a processor-based device. The processor-based device will generally comprise a processor attached to one or more memory devices or other tools for persisting data. These memory devices will be operable to provide machine-readable instructions to the processors and to store data. Certain embodiments may include data acquired from remote servers. The processor may also be coupled to various input/output (I/O) devices for receiving input from a user or another system and for providing an output to a user or another system. These I/O devices may include human interaction devices such as keyboards, touch screens, displays and terminals as well as remote connected computer systems, modems, radio transmitters and handheld personal communication devices such as cellular phones, “smart phones”, digital assistants and the like.

The processing system may also include mass storage devices such as disk drives and flash memory modules as well as connections through I/O devices to servers or remote processors containing additional storage devices and peripherals.

Certain embodiments may employ multiple servers and data storage devices thus allowing for operation in a cloud or for operations drawing from multiple user-selected data sources. The inventor contemplates that the methods disclosed herein will also operate over a network such as the Internet, and may be effectuated using combinations of several processing devices, memories and I/O. Moreover, any device or system that operates to effectuate techniques according to the current disclosure may be considered a server for the purposes of this disclosure if the device or system operates to communicate all or a portion of the operations to another device.

The processing system may be a wireless device such as a smart phone, personal digital assistant (PDA), laptop, notebook and tablet computing devices operating through wireless networks. These wireless devices may include a processor, memory coupled to the processor, displays, keypads, WiFi, Bluetooth, GPS and other I/O functionality. Alternatively, the entire processing system may be self-contained on a single device.

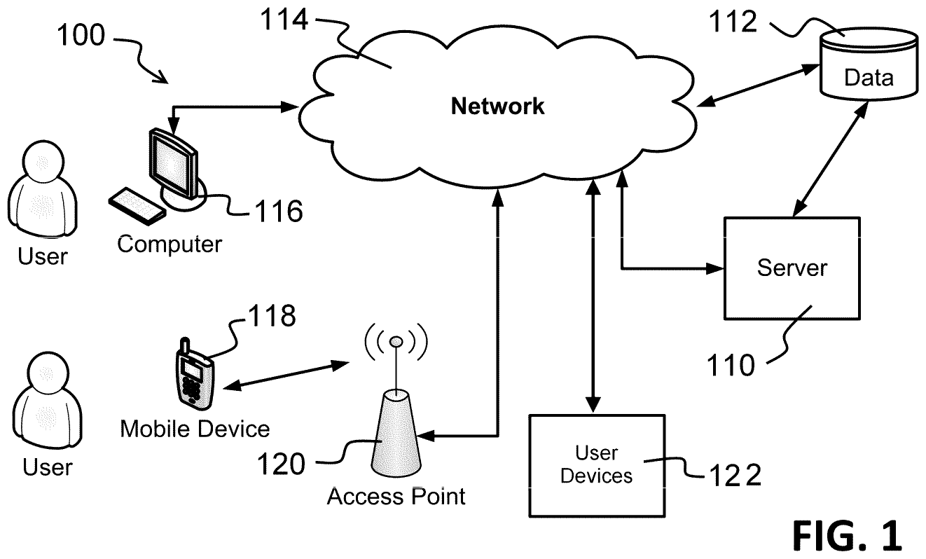

FIG. 1 shows a functional block diagram of a client server system 100 that may be employed for some embodiments according to the current disclosure. In FIG. 1 a server 110 is coupled to one or more databases 112 and to a network 114. The network may include routers, hubs and other equipment to effectuate communications between all associated devices. A user accesses the server by a computer 116 communicably coupled to the network 114. The computer 116 includes a sound capture device such as a microphone (not shown). Alternatively, the user may access the server 110 through the network 114 by using a smart device such as a telephone or PDA 118. The smart device 118 may connect to the server 110 through an access point 120 coupled to the network 114. The mobile device 118 includes a sound capture device such as a microphone. Other connected user devices 122 may also be employed in certain embodiments.

Conventionally, client server processing operates by dividing the processing between two devices such as a server and a smart device such as a cell phone or other computing device. The workload is divided between the servers and the clients according to a predetermined specification. For example, in a “light client” application, the server does most of the data processing and the client does a minimal amount of processing, often merely displaying the result of processing performed on a server.

According to the current disclosure, client-server applications are structured so that the server provides machine-readable instructions to the client device and the client device executes those instructions. The interaction between the server and client indicates which instructions are transmitted and executed. In addition, the client may, at times, provide for machine readable instructions to the server, which in turn executes them. Several forms of machine-readable instructions are conventionally known including applets and are written in a variety of languages including Java and JavaScript.

Client-server applications also provide for software as a service (SaaS) applications where the server provides software to the client on an as needed basis.

In addition to the transmission of instructions, client-server applications also include transmission of data between the client and server. Often this entails data stored on the client to be transmitted to the server for processing. The resulting data is then transmitted back to the client for display or further processing.

One having skill in the art will recognize that client devices may be communicably coupled to a variety of other devices and systems such that the client receives data directly and operates on that data before transmitting it to other devices or servers. Thus data to the client device may come from input data from a user, from a memory on the device, from an external memory device coupled to the device, from a radio receiver coupled to the device or from a transducer coupled to the device. The radio may be part of a wireless communications system such as a “WiFi” or Bluetooth receiver. Transducers may be any of a number of devices or instruments such as thermometers, pedometers, health measuring devices and the like.

A client-server system may rely on “engines” which include processor-readable instructions (or code) to effectuate different elements of a design. Each engine may be responsible for differing operations and may reside in whole or in part on a client, server or other device. As disclosed herein a display engine, a data engine, an execution engine, a user interface (UI) engine and the like may be employed. These engines may seek and gather information about events from remote data sources. Besides engines for querying and reporting on data, certain embodiments may also include an anonymizer engine.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to effect such feature, structure or characteristic in connection with other embodiments whether or not explicitly described. Parts of the description are presented using terminology commonly employed by those of ordinary skill in the art to convey the substance of their work to others of ordinary skill in the art.

### Personally, Identifiable Information

Personally, identifiable information (PII) may include, but is not limited to: names, birth dates, IDs such as the U.S. social security numbers, account numbers (credit card, bank accounts, etc.), addresses, phone numbers and other data whose exposure or misuse creates risk. This type of data is routinely stored in databases. If these databases are compromised, even with internal anonymization techniques, PII may be subject to exposure by experienced data pirates. One benefit of the present disclosure is the ability to reduce or eliminate the risk of exposure of this data in the case of a data breach.

Contextual data is generally data associated with PII but is not personally identifiable. For example, and without limitation, a medical record may include a patient name, age, height, weight, blood pressure and other information. The patent name is PII, while the remainder of the record is contextual data.

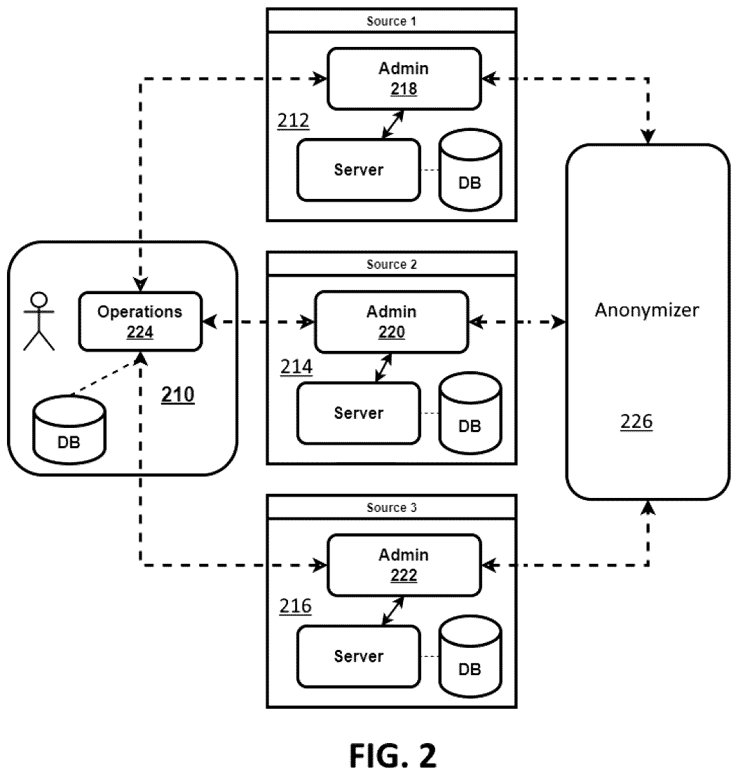

FIG. 2 shows a functional block diagram of a system according to the present disclosure. In FIG. 2 a central processing system 210 includes a processor, a database and an Operations Engine 224 encoded with instructions for performing at least some of the steps described herein. The processing system 210 is coupled to three other remote processing systems 212, 214, and 216. Each remote processing system 212, 214, and 216 includes data information that has personally identifiable information (PII). The remote processing systems with PII data may be spread among various entities such as medical providers, schools, academia, and the like. Three remote systems are shown in FIG. 2 by way of example only and this disclosure may include fewer or more remote systems in certain embodiments.

Each of the remote processing systems has encoded instructions directing the remote processor to perform different functions as described herein. The instructions may be encoded into an administration engine 218 (or “helper”). The administration engine 218 operates to effectuate processing by removing personally identifiable information from data stored in the remote processing system. This may be effectuated using a remote PII system such as an anonymization engine 226 (“Anonymizer”) as described herein.

In operation, a user operating the central processing system 210 requests information using the operations engine 224. The central processing engine 224 connects with the appropriate remote system and forwards the request. Note: requests regarding the same or similar information may be sent to multiple administration engines. The administration engine 218 queries its local data store and separates PII from contextual information in the query results. The administration engine 218 then interfaces with the anonymizer 226 and sends only the PII to the anonymizer 226. The anonymizer 226 then returns a unique identifier for the PII to the administration engine 218. The administration engine 218 unites the contextual information with the unique identifier returned from the anonymizer 226 to create anonymized records stripped of any PII. The anonymized records are transmitted to the operations engine 224 for further operations.

The anonymizer 226 may create the unique identifier from the PII sent to it, or, in some cases, the unique identifier has previously been generated from prior operations. The anonymizer may then re-use the unique identifier in different scenarios where similar PII is provided. Note, contextual information is not provided to the anonymizer.

The processor 210 may collect the anonymized records from multiple sources 212, 214, and 216. These records may be matched through their unique identifiers provided by the anonymizer 226. For example, and without limitation, if Source 1 212 is a school record, and Source 2 214 is a medical record, the unique identifier may tie the two records together without exposing any PII. Then a user may perform analysis to determine any relationship between school performance and medical records without violating any privacy requirements such as HIPPA or FERPA.

Additional data processing steps may be performed by the administration engines 218 such as applying a standardized formatting, standard field naming, and the like. For example, and without limitation, data from disparate sources may require a degree of formatting to ensure like data is compatible with like data. In some embodiments templating may be used to map data from differing data sources into a common, usable format. Moreover, the administration engines 218 may apply a pseudo-identifier (or anonymous ID) for each record to maintain uniqueness and allow for further processing.

The Operations engine 224 collates the datasets returned by the remote processing devices and may effectuate a new data structure including a wide variety of information from multiple sources. For example, and without limitation, school records may be correlated with medical records all related to an individual, yet unknown, person.

### Anonymization Engine

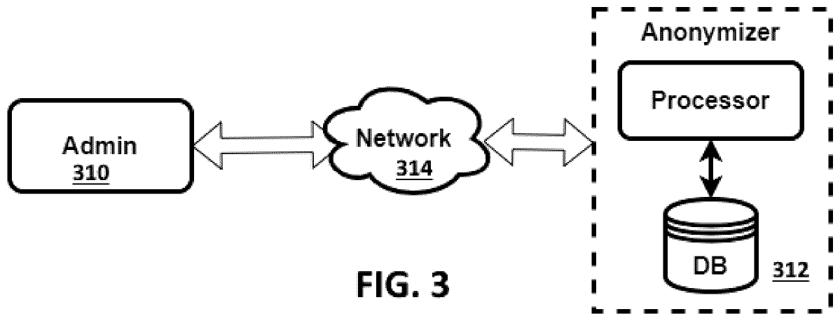

FIG. 3 shows a diagram of an anonymizing process. In FIG. 3 an administration engine 310 is coupled to an anonymizer 312 through a network 314 such as the Internet. Anonymizer 312 operates to transform actual real data including PII to otherwise actual data with the PII either removed or obfuscated such that the actual person the data refers to remains unknown. The anonymizer 312 may return a unique identifier for every unique person (or entity) devoid of any PII. The anonymizer 312 functions without contextual information.

Different embodiments of the present disclosure may be effectuated to meet varying demands of data security. Certain embodiments may include a series of processes generally referred to as an anonymization engine 312. The anonymization engine 312 provides for data transfer between a data source and a data recipient while obfuscating or securing PII. This anonymization engine may include one or more of the following capabilities:
Providing a new and unique identifying value (Anonymous ID) for an entity when requested by a data source providing PII.
Enabling a data recipient to receive the same, but unique, Anonymous ID, for the same individual, when data for that individual is provided by different data sources.
Enabling a data recipient to receive different and unique Anonymous IDs, for the same individual, when PII for that individual is provided by different data sources.
Enabling the data recipient to receive a matching table which will enable them to link the different Anonymous IDs provided by different data sources.
Enabling a specific individual, whose data is being shared, to grant or deny permission for the data recipient to combine their data from specific data sources.
Operating in a unidirectional, asynchronous mode where the data source provides a complete set of data, including PII, where the Anonymization Engine replaces PII with an Anonymous ID.
Operating in a bi-directional, asynchronous mode where the Anonymization Engine receives a complete set of data, including PII, from a data source then sends it to a data recipient, either with or without replacing the PII with the Anonymous ID, and then sends a response from the data recipient to the data source ensuring the PII has been replaced with the Anonymous ID.

Operating in a bi-directional, asynchronous mode where the Anonymization Engine receives a set of data which includes an Anonymous ID, but no PII. The Anonymization Engine may then replace the Anonymous ID with the PII, send the complete set of data to the data recipient, and then return the data recipient's response to the data source.

### Internal and External Identifiers

Each data source using the techniques described herein may have a unique identifier, a poly-identifier, or a globally unique identifier (GUID). Poly-pseudonymization may be used to anonymize PII, not by removing all of the PII but instead by replacing it with syntactically correct but inherently inaccurate values for a poly-identifier. These identifiers may be hashed with a unique identifier that the anonymizer stores to create new identifiers or by other processes to achieve the same result. Hashing may be effectuated by systematically converting one value to another in a manner that allows the first value to be retrieved through an additional hashing step. There may be both internal and external identifiers which allow 3rd parties to use an external identifier for their source. For example, and without limitation, there may be a unique ID for the data source and another for a data destination. Each record containing PII may also include a unique identifier created by hashing both the data source identifier and an identifier for the PII.

In operation the PII and the data source ID may be fed to an anonymizer to create a unique “external” ID that is used only by that data source or the data recipient. While internally the anonymizer keeps its own unique “internal” which may be formed by standard techniques of generating GUIDs or other processes. The IDs or GUIDs may be created dynamically for additional security. For example, and without limitation, a requester for anonymized data may receive a dataset with an external ID, wherein a second requester for the same dataset may receive it with a different external ID. Moreover, a single requester may receive identical datasets with different external IDs depending on the conditions of the request. This may further obfuscate preventing PII from being compromised.

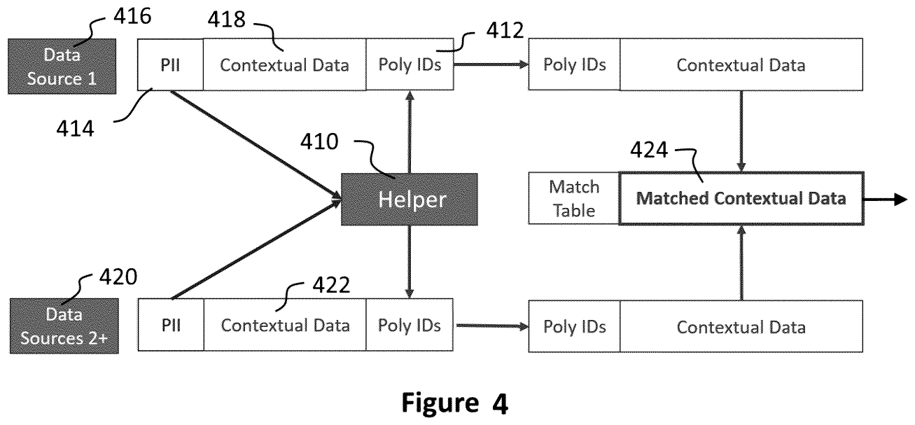

FIG. 4 illustrates certain operations of an administration engine (or helper) 410. A helper removes PII in relation to a poly-anonymous identifier (“Poly IDs”) 412. A poly-anonymous identifier 412 is a unique identifier stripped of any recognizable PII. The helper may include encrypted or non-encrypted data. The Poly ID 412 may be previously stored or created dynamically depending on the implementation. For example, certain Poly IDs 412 may be a “use once” implementation, while others may be established for long-term implementations and preserved in an anonymizer (not shown here).

In operation the helper 410 receives a request for data from the data sources 416 and 420. These data sources may have PII as well as contextual data. The helper 410 with the use of an anonymizer strips the PII of the records and replaces it with poly identifiers 412. The new record only contains poly identifiers and contextual data. Collectively the new records may be aggregated in a match table thus creating a new dataset of matched contextual data 424 with matched PII but without the PII being exposed to the public. Once aggregated, the data may be queried to determine correlations between different data from divergent data sources. For example, and without limitation, a user may select data sources from a menu, run a query, and get matched contextual data 424 in response to the query. Thus data from a criminal proceeding may be correlated with academic data to determine academic risk for juveniles in the criminal justice system.

### Advantages

The methods and techniques presented herein provide a novel way to merge data from discrepant sources, correlate to determine if the data in those sources relates to a single entity (a person or otherwise) and present the unified data to a requestor in a usable format without divulging any PII. Moreover, even if the source data is compromised there is no relation to the entity whose PII is included. Additionally, if the anonymizer's data is also compromised, there is no relation to the entity whose PII is stored either because of the use of an internal anonymous identifier.

Accordingly, the one advantage is that secure reliable data from different sources may be used without risk of divulging that data inappropriately. For example, and without limitation, for the first time ever, student academic data such as attendance records are able to be analyzed in relationship with the medical care and services those students have received for cross-sector collaboration to solve complex problems. Notable findings include:
a. Of all health services received by kids, the top 4 that impact attendance the most are mental health related: anxiety, depression, other mental disorders, and ADHD.
b. Average school days absent per year are caused by anxiety (20 days), depression (17 days), Other (16 days), and ADHD (10 days).
c. Total school days absent in the school district by health issue: anxiety (230,000), depression (260,000), other mental disorders (80,000), and ADHD (180,000).
d. Average GPA by disorder: anxiety (0.3), depression (1.8), other mental disorders (2.6), and ADHD (2.7).
e. Absenteeism spikes dramatically for patients with mental health issues between the age of 12 and 13, and GPA sharply declines from 12 to 13 years for patients with mental health issues.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of any claims. Accordingly, it is appropriate that the appended claims be construed broadly and in a manner consistent with the scope of the invention, as set forth in the attached claims.

What is claimed:

1. A method including:
disposing a plurality of administration engines on a plurality of remote processing devices, said processing devices coupled to an anonymization engine through a network, said anonymization engine operable to replace personally identifiable information (PII) with a unique identifier;
coupling the plurality of administration engines to a server through the network;
transmitting a first query to a first administration engine and receiving a first result in response to said first query, said first result including first contextual information and a first unique identifier;
transmitting a second query to a second administration engine and receiving a second result in response to said second query, said second result including second contextual information and a second unique identifier, said second contextual information including information different from said first contextual information;
associating the first contextual information with the second contextual information in response to the first and second unique identifier;
formatting the first contextual information and the second contextual information to ensure data compatibility, and
querying the first and second contextual information to determine one or more relationships between the first and second contextual information.

2. The methods of claim 1 further including templating to map data from differing data sources into a standard format.

3. The methods of claim 1 wherein the first contextual information is academic information.

4. The method of claim 1 wherein the first contextual information is health information.

5. The method of claim 1 wherein the one or more relationships between the first and second contextual information indicate academic performance and mental health.

6. The method of claim 1 wherein the unique identifier is created using Poly-pseudonymization.

7. A method including:
receiving, at a server, a first contextual information from a first remote data source, said first remote data source including mental health information and a first poly-anonymous identifier;
receiving at the server a second contextual information from a second remote data source, said second remote data source including academic information and a second poly-anonymous identifier;
correlating the first and second contextual information in response to matching poly-anonymous identifiers, wherein,
relationships between the first and second contextual information is quantified.

8. The methods of claim 7 further including templating to map data from the first contextual information and the second contextual information sources into a standard format.

9. A method including:
presenting to a user a menu, said menu including a first menu item, said first menu item representing a first data source including a first contextual information;
said menu further including a second menu item, said second menu item representing a second data source including a second contextual information, said second contextual information different from the first contextual information;
receiving from a user, a plurality of menu items selections;
querying each of said a data stores for contextual information, said contextual information not including PII, and
correlating the first and second contextual information to form matched contextual information.

10. The method of claim 9 wherein the first contextual information is health information.

11. The method of claim 9 wherein the correlating the first and second contextual information indicates academic performance and mental health.

12. The method of claim 9 wherein a unique identifier is created in lieu of PII.
